(19) United States
(12) Patent Application Publication
(10) Pub. No.: US 2008/0001371 A1
(43) Pub. Date: Jan. 3, 2008

(54) Sanitary sleeve for shopping cart handle

(76) Inventor: Cecile Rabiea, Lattington, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/477,173

(22) Filed: Jun. 28, 2006

(51) Int. Cl. B62D 39/00

(52) U.S. Cl. 280/33.992

(57) ABSTRACT

A sleeve is provided for covering a shopping cart handle. The sleeve includes a generally cylindrical hollow member having a slit along the length thereof. The member is made of sufficiently flexible plastic material so as to permit it to receive the cart handle and to closely conform to the shape of the cart handle to cover the cart handle during use and to permit the sleeve to be removed from the cart handle after use. The process of fabricating the sleeve, as well as apparatus for displaying packaged sleeves and collection used sleeves, are also described.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present application relates to shopping carts used for transporting products in retail stores, for example food products in a supermarket or toys in a toy store, and more particularly, a sanitary sleeve for covering the handle of a shopping cart, a method for fabricating such a sleeve and apparatus for the display of unused sleeves and collection of used sleeves.

2. Description of Prior Art Including Information Disclosed Under 37 CFR 1.97 and 1.98

Shopping carts of various types are widely used in grocery and other types of retail stores to transport products. Such carts expose shoppers, including small children who often ride in the carts, to various types of harmful bacteria from a variety of sources such as raw meats and chicken, young children in diapers, as well viruses from people's hands who are sick. Further, the carts are often left on the streets, sometimes in the possession of homeless people, and thereafter returned to the store where they are put back into service without cleaning. Understandably, various city health departments have expressed concerns for the safety of those using unsanitary carts.

The purpose of my invention is to provide a safe, inexpensive and effective solution to this problem. The invention includes sleeves for mounting on shopping cart handles and other cylindrical portions of shopping carts that are provided to customers in sanitary packages. It also includes a method of manufacturing such sleeves and apparatus for displaying the sanitary packages and for collecting used sleeves.

### BRIEF SUMMARY OF THE INVENTION

It is, therefore, a prime object of the present invention to provide sanitary sleeves for shopping cart handles.

It is another object of the present invention to provide sanitary sleeves for shopping cart handles that are easy to use and inexpensive to manufacture.

It is another object of the present invention to provide a method of manufacturing sanitary sleeves for shopping cart handles.

It is another object of the present invention to provide apparatus for displaying sanitary sleeves for shopping cart handles.

It is another object of the present invention to provide apparatus for collecting used sanitary sleeves for shopping cart handles.

Those objects are achieve by the present invention which, in general relates to a sanitary sleeve for a shopping cart handle, a method of manufacturing the sleeve and an apparatus for displaying unused sleeves and collecting used sleeves.

In accordance with one aspect of the present invention, a sleeve is provided for covering a shopping cart handle. The sleeve includes a generally cylindrical hollow member having a slit along the length thereof. The member is made of sufficiently flexible material so as to permit it to receive the cart handle and to closely conform to the shape of the cart handle to cover the cart handle during use and to permit the sleeve to be removed from the cart handle after use.

The sleeve may include a printable surface. The surface may be imprinted with an advertisement or other indicia.

Preferably sanitary packaging for enclosing the sleeve is provided. Two sleeves may be situated in each package.

In accordance with another aspect of the present invention, a shopping cart with a handle and a sleeve for covering the shopping cart handle are provided in combination. The sleeve includes a generally cylindrical hollow member adapted to be removably mounted on the shopping cart handle.

The member is made of sufficiently flexible material so as to closely conform to the shape of the shopping cart handle when mounted thereon.

The member has a slit along the length thereof such that the handle can be received therein.

The combination further includes sanitary means for packaging the sleeve.

In accordance with another aspect of the present invention, sleeve means for covering a shopping cart handle are provided. The sleeve means includes first and second generally cylindrical hollow members. Each of the members has a slit along the length thereof. The members are adapted for removable mounting in end-to-end relation on the handle of a shopping cart.

The sleeve means also includes sanitary means for packaging the first and second members. The members may be situated one within the other in the sanitary packaging.

The sleeve members are adapted to be mounted on the handle of the shopping cart in spaced end-to-end relation.

In accordance with another aspect of the present invention, a display for sleeve means adapted to cover a shopping cart handle is provided. Each of the sleeve means include at least one generally cylindrical hollow member situated in sanitary packaging. The display includes means for retaining a plurality of the packaged members in upstanding, side-by-side relation. The retaining means has an opening to facilitate removal of the packaged members.

The display also includes one or more receptacles situated proximate the retaining means. The receptacles are adapted to receive used members. Means are provided for attaching the receptacles to the retaining means.

A stand for the retaining means may be provided.

A header situated proximate the retaining means may be provided.

A cover for the retaining means may be provided.

Preferably, the retaining means takes the form of a shipping carton.

In accordance with another aspect of the present invention, a method for fabricating a sleeve for a shopping cart handle is provided. The method includes the steps of: (a) extruding a plastic sheet; (b) die-cutting the extruded plastic sheet; (c) rolling the cut plastic sheet; (d) placing the rolled plastic sheet in a mold; (e) heating the rolled plastic sheet in the mold; (f) cooling the heated plastic sheet; and (g) removing the cooled rolled plastic sheet from the mold.

The plastic sheet is preferably made of PVC. The plastic sheet is extruded to a thickness of about 0.4 mm. The surface of the plastic sheet may be printed with advertising indicia.

The mold has a cavity into which the rolled plastic sheet is placed. The cavity is about 25 mm in diameter.

The plastic sheet is heated to approximately 90° F.

After it is cooled, the rolled plastic sheet is inserted into a sanitary package. The sanitary package is then sealed. Preferably, two of the cooled rolled plastic sheets are inserted into each sanitary package. One of the sheets may be situated within the other before sealing the sanitary package. Insertion of one sheet into the other may take place before inserting the sheets into the sanitary package.

### BRIEF DESCRIPTION OF THE SEVERAL VIEWS OF DRAWINGS

To these and to such other objects that may hereinafter appears, the present invention relates to a sanitary sleeve for a shopping cart handle, as described in detail in the following specification and recited in the annexed claims, taken together with the accompanying drawings, in which like numerals refer to like parts and in which:

FIG. 1 is an environmental view of the display and collection apparatus of the present invention as it would appear in use;

FIG. 2 is an isometric view of the display and collection apparatus;

FIG. 3 is an isometric view of the display for the packages sleeves;

FIG. 4 is an exploded isometric view showing the packaged sleeves;

FIG. 5 is an isometric view of a shopping cart handle showing one sleeve mounted thereon and a second sleeve in position to be mounted;

FIG. 6 is a cross-sectional view taken along line 6-6 of FIG. 5; and

FIG. 7 is a flow chart of the manufacturing process.

### DETAILED DESCRIPTION OF THE INVENTION

As seen in FIGS. 4, 5 and 6, one aspect of the present invention relates to a sleeve 10 provided for covering the handle 12 or other cylindrical portion of a shopping cart 14. Sleeve 10 is a generally cylindrical hollow member having a slit 16 along the length thereof.

Sleeve 10 is made of sufficiently flexible material, such as plastic, preferably PVC, so as to permit it to receive cart handle 12. Once in place, it will closely conform to the shape of the cart handle to cover the cart handle during use. This flexibility will also permit the sleeve to be removed from the cart handle after use.

As illustrated in FIG. 5, the sleeve 10 is mounted on handle 12 by aligning the sleeve with the handle so that slit 16 is facing the handle. Then, one end of the sleeve is snapped over the handle and the remained of the sleeve is gradually worked onto the handle. The flexibility of the material from which the sleeve is made permits the edges that define the slit to part enough to receive the handle and then return to their original position once the sleeve is mounted. Removal of the sleeve requires the opposite operation. The sleeve is grasped at one end and moved away from the handle until the entire sleeve is freed from the handle.

As seen in FIG. 5, the sleeve may include a printable surface. The sleeve surface may be imprinted with an advertisement or other indicia, such as the logo of the store or a product that is being promoted.

Preferably, sanitary packaging for enclosing the sleeve is provided, as seen in FIG. 4. The package is essentially a paper bag 18, sealed at each end, to keep the sleeves 10 therein sanitary prior to use. The bag is easily opened by tearing either end. Two sleeves 10 may be situated in a single bag 18, as illustrated in FIG. 4. The bag may have indicia printed thereon as well.

As seen in FIG. 5, two sleeves 10 may be mounted in end-to-end relation on the handle 12 of the shopping cart. A small space may be situated between the mounted sleeves as a separate sleeve is provided for each hand of the user.

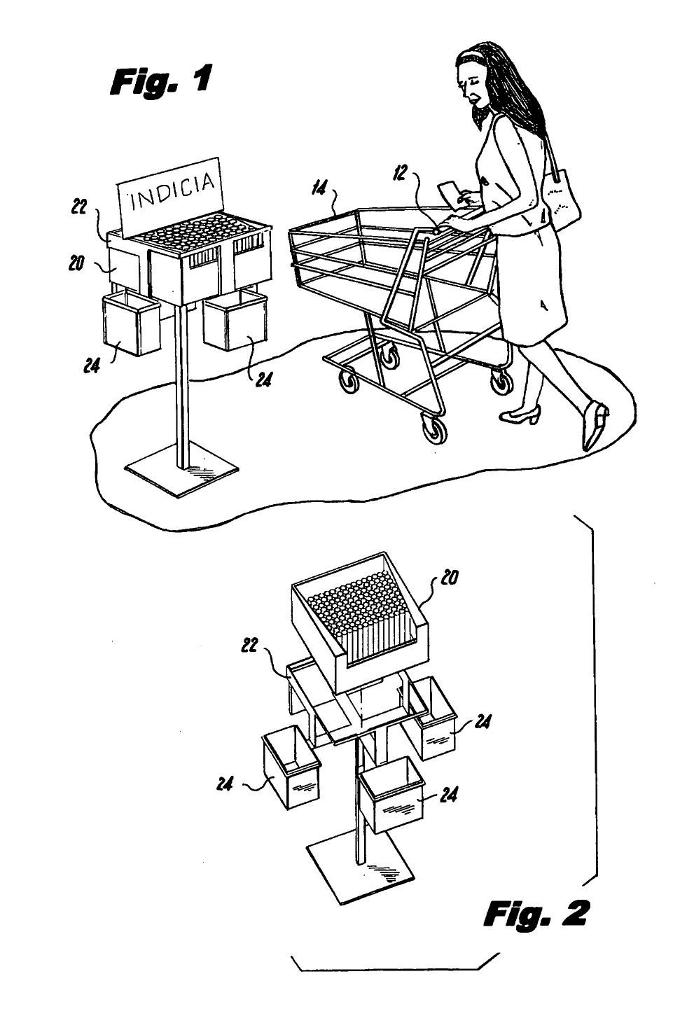

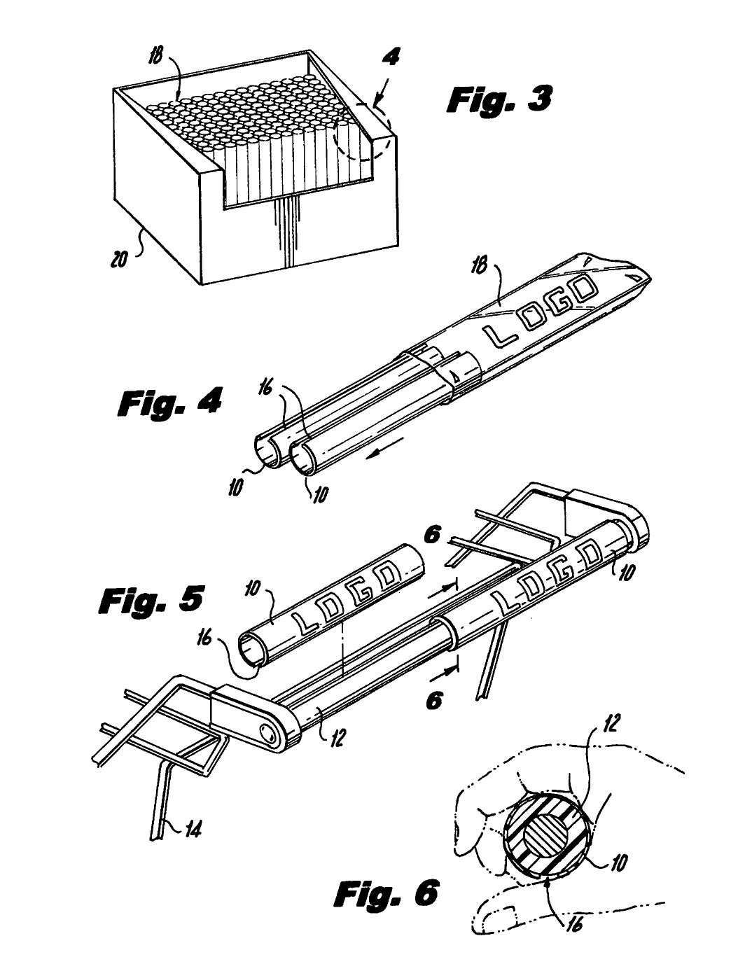

Another aspect of the present invention relates to an apparatus for the display of the packages sleeves and for collection of used sleeves and bags, as illustrated in FIGS. 1, 2 and 3. Referring first to Figure, the packaged sleeves are received from the factory in upstanding, side-by-side relation, within a retainer, preferably a shipping carton 20. Two sleeves are situated within each bag 18. The carton is shipped with a lid which is removed to expose the top and a portion of the front of the carton, as shown in FIG. 3. The opening is to facilitate removal of the packaged sleeves from the carton.

As seen in FIGS. 1 and 2, a stand 22 is provided to hold carton 20 at a convenient height for a shopper such that the shopper can easily remove packaged sleeves from the carton. Once a package is removed, the shopper tears open one end and mounts the sanitary sleeves on the shopping cart as described above.

The shopper than discards the empty bag by placing it in one of the collection receptacles 24 attached to the stand adjacent the front and sides of carton 20. The same collection receptacles may be used to discard the sleeves after they are removed from the cart.

As seen in FIG. 1, a header situated proximate the carton may be provided. The header may have indicia printed thereon, including instructions as to how to use the sleeves and promotional materials, as well.

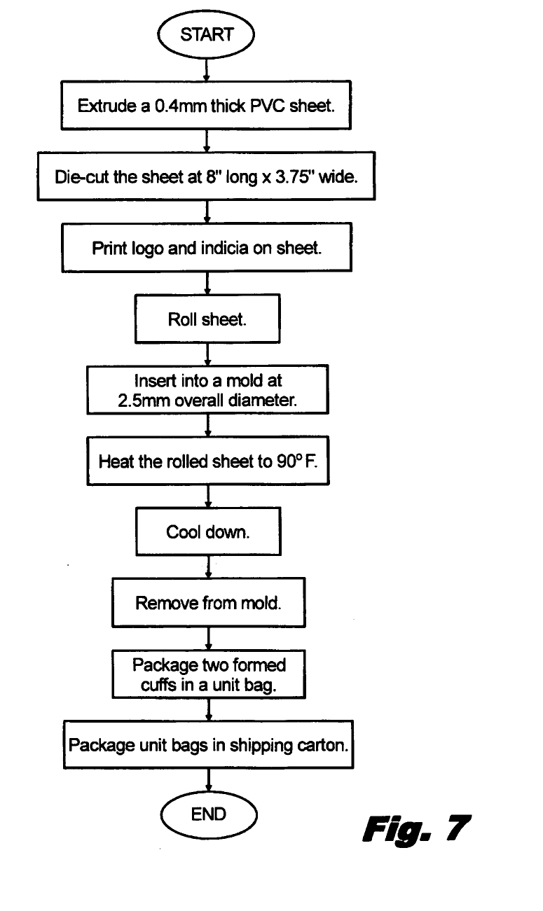

Another aspect of the present invention has to do with the method for fabricating the sleeve. As illustrated in FIG. 7, the method begins by extruding a 0.4 mm thick PVC sheet. The extruded sheet is then die-cut to approximately 8 inches long by 3.75 inches wide. Logos and indicia are printed on the sheet. The cut plastic sheet is then rolled and placed into a mold with a 2.5 mm cavity where it is heated to approximately 90 degrees F. The heated plastic sheet is allowed to cool and then is removed from the mold. The completed sleeves are then placed in bags, two to a bag, and the packaged sleeves are placed into a shipping carton.

One of the sleeves may be situated within the other before sealing the sanitary package. Insertion of one sheet into the other may take place before inserting the sheets into the sanitary package.

It will now be appreciated that the present invention relates to a sanitary sleeve for use on a shopping cart handle, a method for fabricating the packaged sleeve and apparatus for display the packaged sleeves and for collection used sleeves.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A sleeve for covering a shopping cart handle comprising a generally cylindrical hollow member having a slit along the length thereof, said member being made of sufficiently flexible material so as to permit said member to receive the cart handle and to closely conform to the shape of the cart handle to cover the cart handle during use and to permit said member to be removed from the cart handle after use.

2. The sleeve of claim 1 comprising a printable surface.

3. The sleeve of claim 2 wherein said printable surface is printed with indicia.

4. The sleeve of claim 1 further comprising sanitary packaging for enclosing said sleeve.

5. The sleeve of claim 4 wherein two of said sleeves are situated in said packaging.

6. In combination, a shopping cart with a handle and a sleeve for covering the shopping cart handle, said sleeve comprising a generally cylindrical hollow member adapted to be removably mounted on the shopping cart handle.

7. The combination of claim 6 wherein said member is made of sufficiently flexible material so as to closely conform to the shape of the shopping cart handle when mounted thereon.

8. The combination of claim 6 wherein said member has a slit along the length thereof.

9. The combination of claim 6 further comprising sanitary means for packaging said sleeve.

10. The combination of claim 6 further comprising a pintable surface on said member.

11. The combination of claim 10 wherein said printable surface comprises an advertisement.

12. Sleeve means for covering a shopping cart handle comprising first and second generally cylindrical hollow members, each of said members having a slit along the length thereof, said members being adapted for removable mounting in end-to-end relation on the handle of a shopping cart.

13. The sleeve means of claim 12 further comprising sanitary means for packaging said first and second members.

14. The sleeve means of claim 13 wherein said members are situated one within the other in said sanitary packaging means.

15. The sleeve means of claim 12 wherein said members are adapted to be mounted on the handle of the shopping cart in spaced end-to-end relation.

16. A display for sleeve means adapted to cover a shopping cart handle, each of said sleeves means comprising at least one generally cylindrical hollow member situated in sanitary packaging, said display comprising means for retaining a plurality of said packaged members in upstanding, side-by-side relation, said means having an opening to facilitate removal of the packaged members.

17. The display of claim 16 further comprising at least one receptacle situated proximate said retaining means adapted to receive used members.

18. The display of claim 16 further comprising a stand for said retaining means.

19. The display of claim 17 further comprising means for attaching said receptacle to said retaining means.

20. The display of claim 16 further comprising a header situated proximate said retaining means.

21. The display of claim 16 further comprising a cover for said retaining means.

22. The display of claim 17 further comprising a second receptacle adapted to receive used members and means for attaching said receptacles proximate the front and sides of said retaining means, respectively.

23. The display of claim 16 wherein said retaining means comprises a shipping carton.

24. A method for fabricating a sleeve for a shopping cart handle, said method comprising the steps of:
(a) extruding a plastic sheet;
(b) die-cutting the extruded plastic sheet;
(c) rolling the cut plastic sheet;
(d) placing the rolled plastic sheet in a mold;
(e) heating the rolled plastic sheet in the mold;
(f) cooling the heated plastic sheet; and
(g) removing the cooled rolled plastic sheet from the mold.

25. The method of claim 24 wherein said plastic sheet is PVC.

26. The method of claim 24 wherein the plastic sheet is extruded to a thickness of about 0.4 mm.

27. The method of claim 24 further comprising the step of printing the surface of the plastic sheet.

28. The method of claim 24 wherein the mold has a cavity into which the rolled plastic sheet is placed and wherein said cavity is about 25 mm in diameter.

29. The method of claim 24 wherein the plastic sheet is heated to approximately 90° F.

30. The method of claim 24 further comprising the steps of inserting the cooled rolled plastic sheet into a sanitary package and sealing the sanitary package.

31. The method of claim 24 further comprising the steps of inserting two of the cooled rolled plastic sheets into a sanitary package and sealing the sanitary package.

34. The method of claim 31 wherein one of said sheets is situated within another of said sheets before sealing the sanitary package.

35. The method of claim 31 wherein one of said sheets is situated within another of said sheets before inserting the sheets into the sanitary package.
